(19) United States
(12) Patent Application Publication
(10) Pub. No.: US 2001/0040198 A1
(43) Pub. Date: Nov. 15, 2001

(54) Shredding roller

(76) Inventor: Peter Rossler, Ilsfeld (DE)

Correspondence Address: FACTOR & PARTNERS, LLC, 1327 W. WASHINGTON BLVD., SUITE 5G/H, CHICAGO, IL, 60607, US

(21) Appl. No.: 09/844,167

(22) Filed: Apr. 27, 2001

(30) Foreign Application Priority Data
Apr. 29, 2000 (DE) 200 07 786.4

(51) Int. Cl. B02C 4/30

(52) U.S. Cl. 241/294

(57) ABSTRACT

A shredding roller (10) has a roller core (12) and a plurality of cutter blades (22) supported by the roller core (12). The roller core (12) possesses an axial cavity (38). A plurality of penetration apertures (36) for shredded material are provided in the sheath (35) of the roller core (12), which surrounds the axial cavity (38). At least one discharge aperture (39) for shredded material is provided in at least one axial end area of the roller core (12). A shredding roller of this type increases the throughput of a shredding machine for shredded material.

### DESCRIPTION

The invention concerns a shredding roller according to the pre-characterising clause of claim 1.

Known shredding rollers of this type are constituent parts of shredding machines with which waste, for example, wood waste, is shredded. During this process, the material to be shredded is shredded between the cutter blades and an opposing blade, permanently fixed to the frame of the shredding machine. Prior art shredding rollers have a closed outer sheath surface. Shredded material must run between the cutter blades and the opposing blade first so that it can be trapped in a collecting area, arranged under the shredding roller and transported away. This limits the throughput.

It is therefore the object of the present invention to create a further development of a shredding roller of the type described initially in such a way that shredded material is routed to the collecting area more efficiently.

This object is achieved according to the invention by a shredding roller with the features stated in claim 1.

Shredded material can reach the inside of the roller core of the shredding roller through the large number of penetration apertures in the sheath of the shredding roller, from which point it can be conveyed away through a discharge aperture in the shredding roller. The size of the penetration apertures also permits the size of the proportions of the shredded material to be separated out to be specified, i.e. the shredding roller acts simultaneously as a screen, which is additional to a screen which may optionally be present surrounding the shredding roller. If these screen apertures are of a different size and/or geometry from the penetration apertures in the sheath, a shredding machine fitted with the shredding roller according to the invention can produce two different fractions of shredded material.

If the inner cavity of the roller core is cone-shaped as stated in claim 2, conveying the shredded material reaching the inside of the roller core through the penetration apertures to the discharge aperture is be assisted by the force of gravity.

A comparable gravitational effect to convey shredded material from the cavity of the roller core is produced by the design of the shredding roller according to claim 3.

The roller core can take the form according to claim 4 to permit the largest possible unobstructed cross-section of the discharge aperture of the roller core. One axial end of the roller core then has no bearing and can have a generously dimensioned discharge aperture.

A conveying device according to claim 5 causes or supports the conveying of shredded material out of the roller core if sufficient conveying from the core of the roller is not produced by shredded material pushing from behind or the force of gravity.

The conveying device according to claim 6 is extremely efficient and has a simple structure.

The conveying device according to claim 7 is well adjusted to the geometrical circumstances within the core of the roller.

A conveying screw according to claim 8 adjusts well to cross-sectional changes inside the roller core.

The arrangement of a conveying screw according to claim 9 leads to a relative movement of the conveying screw in respect of the inner surface of the sheath of the roller core. This relative movement increases conveying efficiency even further.

The design of the shredding roller according to claim 10 guarantees conveying shredded materials from the shredding roller with a single conveying device not only within the core of the roller but also via the hollow stump shaft which forms the discharge aperture in this case. The discharge aperture can then be designed with a relatively small diameter so that the hollow stump can be mounted simply.

An arrangement of the cutter blades according to claim 11 leads to a shredding machine with a high throughput because the interaction of the cutter blades and the opposing blade results in shredded material being able to pass through the penetration apertures immediately.

Worn cutter blades can be replaced according to the design described in claim 12.

The invention is described in greater detail below on the basis of examples of embodiments, making reference to the drawing.

These show:

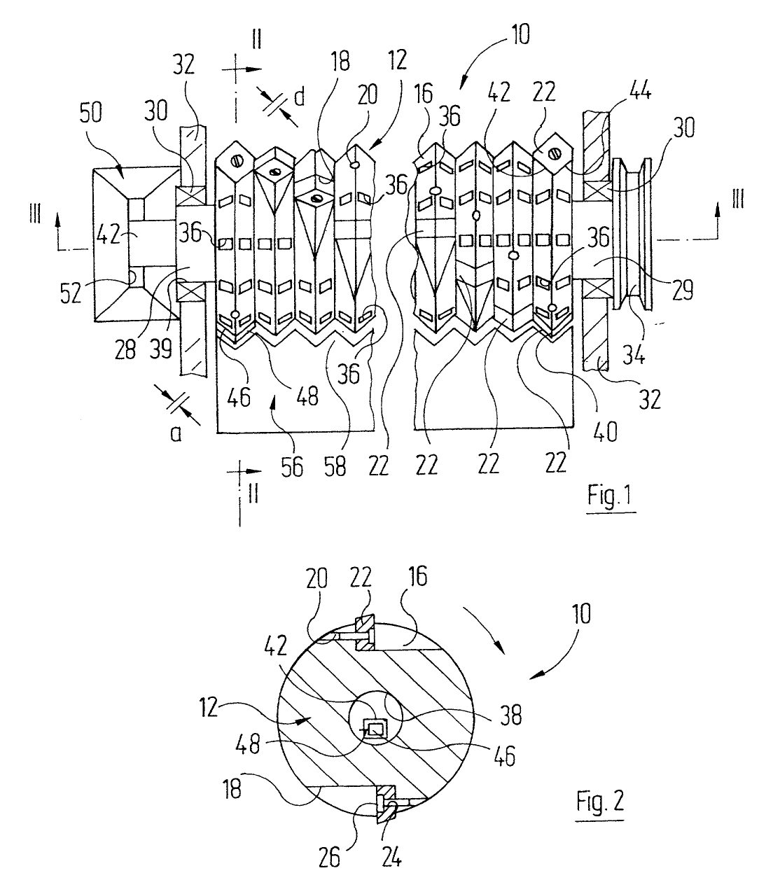

FIG. 1: A schematic top view of a shredding machine for wood waste;

FIG. 2: A transverse section through a shredding roller of the shredding machine shown in FIG. 1 in the central plane of a circumferential rib of the shredding roller (along the section line II-II of FIG. 1);

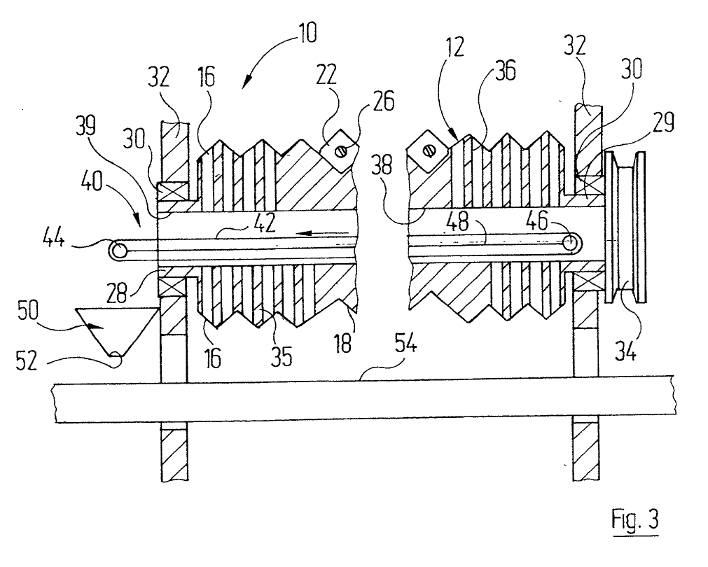

FIG. 3: A section along the axis of the shredding roller of FIG. 1 along the section line III-III of FIG. 1;

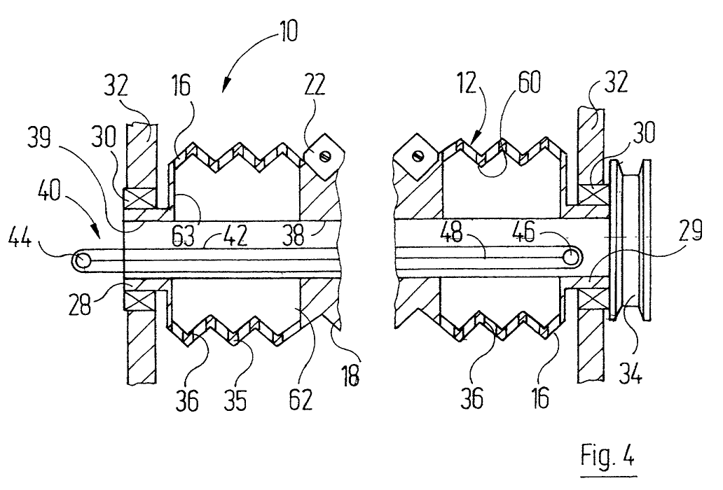

FIG. 4: A similar view to FIG. 3 of an alternative embodiment of the shredding roller;

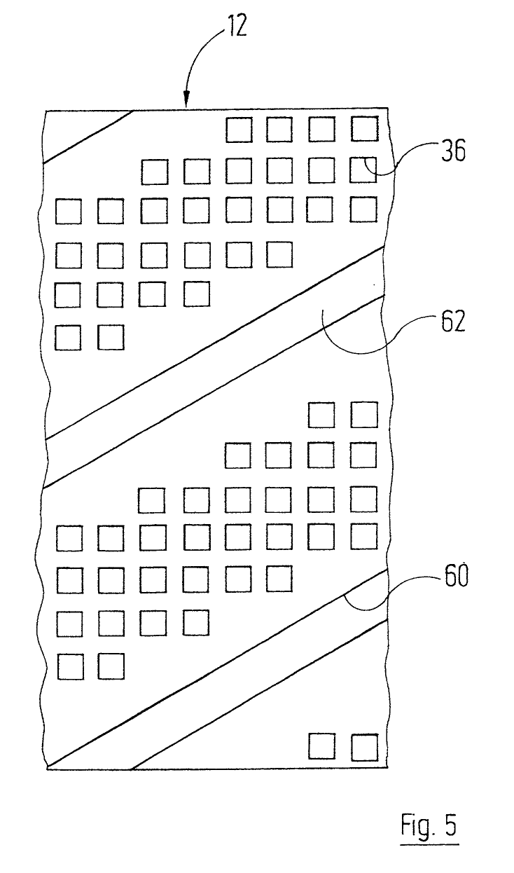

FIG. 5: An enlarged schematic top view of a part of the uncurled inner sheath surface of the shredding roller from FIG. 4;

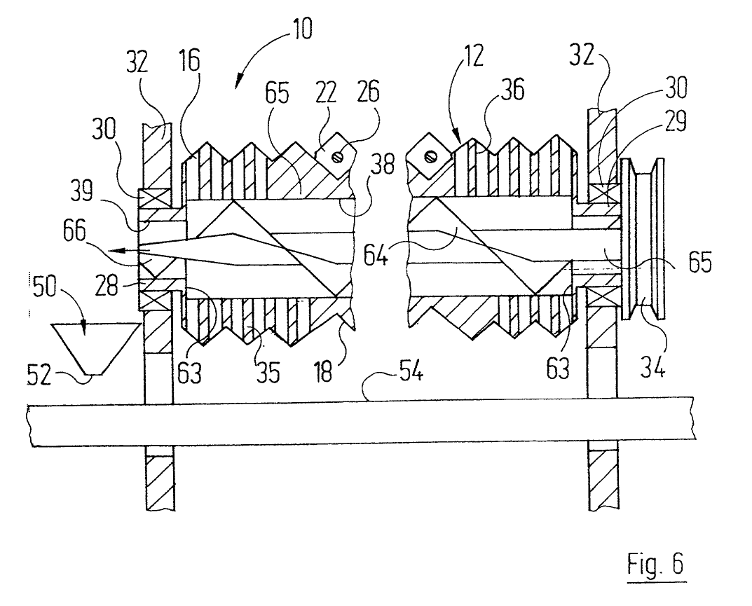

FIGS. 6 to 8: Similar views to FIGS. 3 and/or 4 of alternative embodiments of the shredding roller; and

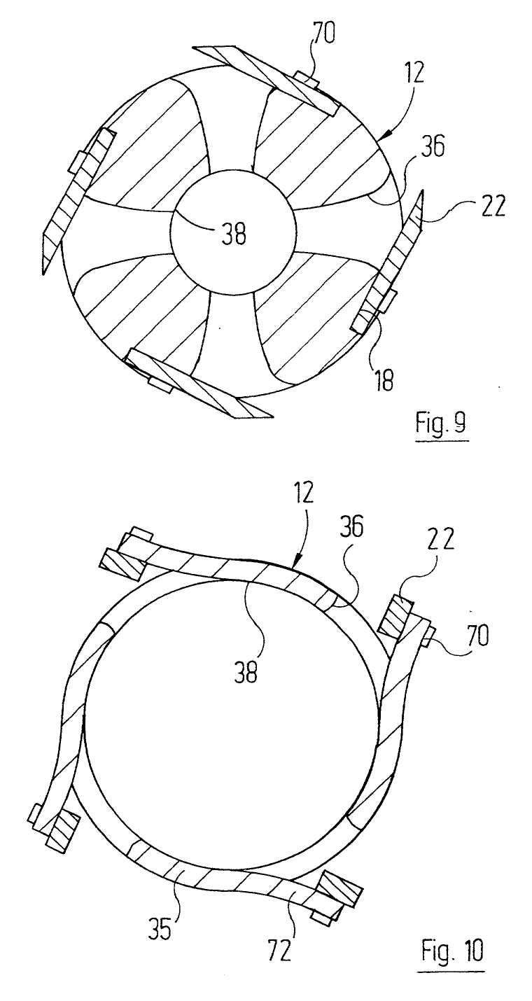

FIGS. 9 and 10: Transverse sections through further modified shredding rollers.

In the drawing, 10 refers to a shredding roller as a whole, to which a roller core 12 belongs. This has several axial circumferential ribs 16 one after the other in the circumferential direction, each with a triangular cross-section.

Blade holders 18 are milled into the circumferential ribs 16 at respective diametrically opposed points. The blade holders 18 of adjacent circumferential ribs 16 are offset at an angle, at 30° in the embodiment under consideration here, in practice at a smaller angle, e.g. 15°. As is shown in FIGS. 1 and 2, the base of the blade holders 18 runs over somewhat more than half a secant of the circular cross-sectional shape of the shredding roller 12. One tapped hole 20 respectively is provided in the base of the blade holder 18 in the circumferential ribs 16 behind the secant section.

One blade unit 22 respectively with a through bore 24 is seated in front of the step formed by the base of the blade holder 18, which has a substantially radial line. A threaded bolt 26 extends through the bore which runs in the tapped hole 20. In practice the blade holder 18 can be milled right through the roller core 12 initially and a piece of material containing the tapped hole 20 can then be welded into the end of the blade holder shown in FIG. 2 at top left or lower right.

The roller core 12 has two lateral stump shafts 28, 29 which run in bearings 30, which are fitted into frame plates 32 of a machine frame of the shredder machine. A belt pulley 34 over which a belt runs which is not shown, driven by a drive motor which is also not shown, is seated on the stump shaft 29 shown on the right.

It is clear from FIGS. 1 to 3 that the roller core 12 of the shredding roller 10 is hollow and has a plurality of radially aligned penetration apertures 36 with a square cross-section in its sheath area 35 which connect the outer area which surrounds the core of the roller 12 with the inner space 38 of the roller core. Each circumferential rib 16 has eight pairs of penetration apertures 36. The circumferential ribs 16 consist of solid material in the area of the blade holders 18 and the blade units 22; therefore there are no penetration apertures here.

The two stump shafts 28, 29 of the roller core 12 are also hollow. Whilst the stump shaft 29 is closed axially by the belt pulley 34, the stump shaft 28 makes a connection outside the system via a discharge aperture 39.

A conveying device 40 is provided in the inside 38 of the roller core 12 (see FIG. 3) which has a conveyor belt 42 running anti-clockwise in FIG. 3, which passes around two guide rollers 44, 46. The latter are supported by a conveying frame 48, only indicated schematically in the drawing, which is connected to the machine frame of the shredding machine.

A discharge funnel 50 is arranged under the discharge end of the conveyor belt 42, which projects through the discharge aperture 39. The discharge aperture 52 of the funnel is above a further conveyor belt 54 of a further conveying device not otherwise shown.

The shredding roller 10 interacts with an opposing blade 56 fixed on a frame, which has a plurality of adjacent, triangular blade sections 58 (cf. FIG. 1). The edges of the blade sections 58 are positioned in such a way that the cutting edges of the blade unit 22 can pass them with a small gap a.

The shredding roller 10 works in the following way:

Material to be shredded, e.g. waste wood, is supplied to the shredding roller 10 from above. The shredding roller 10, driven by the belt pulley 34 and rotating, shreds the material to be shredded between the blade units 22 and the opposing blade 56. Here the shredded material is firstly pressed through the gap between the blade units 22 or the circumferential ribs 16 and the opposing blade 56 during the shredding process and then screened through a screen, not shown in the drawing, attached coaxially under the shredding roller 12 and carried away by a conveyor, not shown. Secondly, shredded material also collects on and above the level of the opposing blade or is pushed back by the shredding roller 12 via the coaxial screen arranged underneath (not shown) into the storage container for material to be shredded.

Lumps of material running on the upper side of the shredding roller 12, which are small enough, fall through the penetration apertures 36 into the inside 38 of the shredding roller 10. Here the penetration apertures 36 function as screening apertures. After the penetration apertures 36, the lumps either fall directly on to the conveyor belt 42 or are carried from the sheath area 35 of the roller core 12 with the rotary movement of the shredding roller 10 and then dropped on to the conveyor belt 42. The material is then conveyed through the discharge aperture 39 using the conveyor belt 42 and falls into the discharge funnel 50 which passes the shredded material through the discharge aperture 52 to the collecting conveyor 54.

Further embodiments of the shredding machine are now described on the basis of FIGS. 4 to 10. Components which correspond to those already described using FIGS. 1 to 3, are given the same reference numbers and are not explained again in detail.

In the embodiment shown in FIGS. 4 and 5, the roller core 12 has a radial expansion 60 of the inner space 38 in the area of the penetration apertures 36. The roller core 12 only continues to consist of solid material, analogous to the embodiment shown in FIGS. 1 to 3, in the areas 62 of the roller core 12 which surround the blade units 22 and/or the blade holders 18.

As is also clear, especially from FIG. 5, which represents the inner sheath surface of a section of the roller core 12 unwound, the area of solid material 62 runs like a screw thread because of the angular displacement of the blade holders 18, described in connection with FIG. 1, and thus simultaneously forms a conveying screw. There is a step 63 (cf. FIG. 4) at the point where the expansion 60 of the inner space 38 is adjacent to the stump shaft 28 on the discharge side.

Shredded material, which passes through the penetration apertures 36 into the inner space 38 of the roller core, is conveyed in the direction of the discharge aperture 39 under the influence of gravity via the rotation of the roller core 12 with the adjacent surfaces of the solid material area tilted in respect of the roller axis. As a result, material shredded for conveying from the inner space 38 receives the conveying effect provided by the belt conveyor 40.

In the embodiment of the roller core 12 shown in FIG. 6, the inner space 38 is provided with a conveying screw 64, which takes over the conveying function of the belt conveyor not present in this case. Here, one core section 65 of the conveying screw 64 is non-rotatably connected to the machine frame (not shown).

Using the conveying screw 64, shredded material within the inner space 38 of the roller core 12 is conveyed in the direction of the arrow to the discharge aperture 39 of the roller core 12 and drops into the discharge funnel 50 from one discharge end 66 of the conveying screw 64 which has a reduced diameter corresponding to the reduction in the diameter of the inner space 38 in the area of the discharge aperture 39. In addition, the conveying screw 64 may consist of flexible material, thereby being able to adjust to the step 63 and to contour changes in the inner surface of the roller core 12.

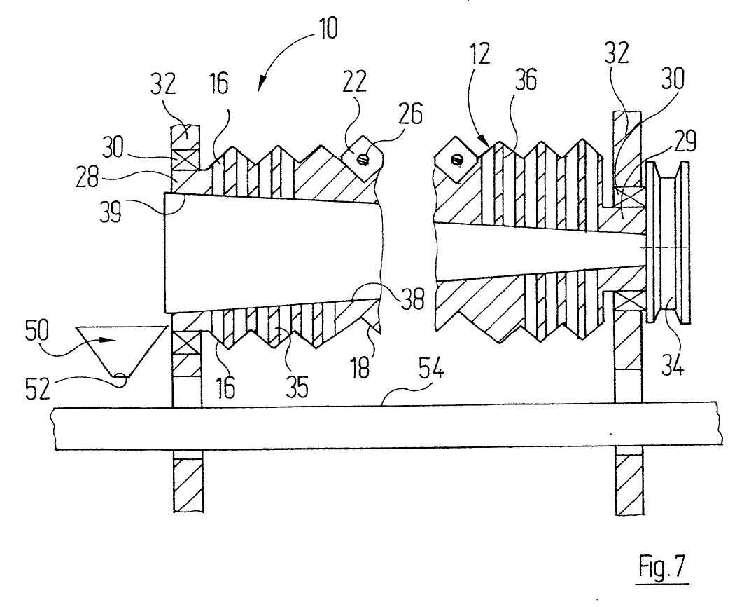

In the embodiment according to FIG. 7, the inner surface of the roller core 12 takes the shape of a stump-ended cone, which opens towards the discharge aperture 39. The arrangement of the blade units 22, the blade holders 38 and the penetration apertures 36 corresponds here to those of the embodiment which was described in FIGS. 1 to 3. Corresponding to the conical shape of the inner space 38 of the roller core 12, the stump shaft 28 facing the discharge funnel has a larger diameter than the stump shaft 28 facing the belt drive 34.

Material which drops into the inner space 38 through the penetration apertures 16 during shredding with the shredding roller 12, is conveyed under the influence of the force of gravity and the rotation of the shredding roller 12 in the direction of the discharge aperture 39.

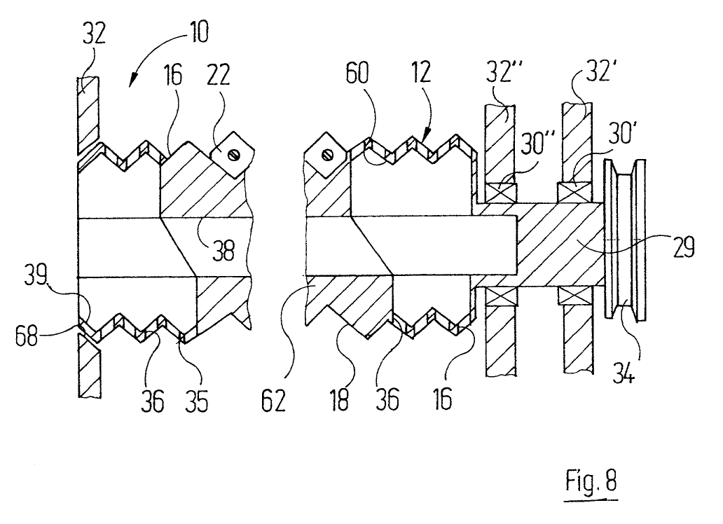

FIG. 8 shows a roller core 12, which has only one stump shaft 28. This is adjacent to the belt pulley 34 and mounted on two bearings spaced at a distance from each other axially 30′, 30″, whereby the bearing 30′ is a fixed bearing and 30″ is a loose bearing.

The roller core 12 is not mounted on a bearing on the end opposite the belt pulley 34. This end with the discharge aperture 39, which passes through an aperture 68 in the frame plate 32 on the discharge side, has an unobscured cross-section which corresponds to that of the extension 60. This discharge aperture 39 in turn is allocated to a discharge funnel which is not shown in FIG. 7.

Since, unlike the embodiment in FIG. 4, the inner space 38 of the roller core 12 in FIG. 8 has no step near the discharge aperture 39, shredded material can be conveyed in the direction of the discharge funnel solely because of the screw shape of the expansion 60. Therefore a belt conveyor (see FIG. 4) is not necessary in this case.

As an alternative or an addition to the embodiments described, the shredding roller can be tilted from the horizontal in the direction of the discharge aperture so that in this way conveying of shredded material within the inner space of the shredding roller towards the discharge aperture takes place solely via the effects of gravity.

In the shredding rollers 12, shown in cross-section in FIGS. 9 and 10, the blade units 22 are arranged immediately adjacent to the penetration apertures 36 and limit the width of the apertures.

In the embodiment in FIG. 9, the-blade units 22 are held in blade holders 18 and are screwed into the latter with screws 70 which are aligned radially. Here the latter are engaged in blind-ended tapped holes (not shown) in the blade holders 18 which pass through continuous bores (not shown) in the blade units.

In the embodiment shown in FIG. 10, the sheathed area 35 of the shredding roller 12 has tongues 72, the surfaces of which are bent outwards. Blade units 22 are screwed with screws 70 to the inner end surfaces 74 of the tongues 72, which represent a continuation of the inner sheath surface of the sheath area 35. The screws pass through continuous bores (not shown) in the inner end surfaces and engage in a blind-ended tapped hole (not shown) in the blade units 22.

1. Shredding roller (10) with a roller core (12) and with a large number of cutter blades (22) supported by the roller core (12), characterised in that the roller core (12) possesses an axial cavity (38), that a plurality of penetration apertures (36) are provided for shredded material in the sheath (35) of the roller core (12) surrounding the cavity and that at least one discharge aperture (39) for shredded material is present in at least one axial end area of the roller core (12).

2. Shredding roller according to claim 1, characterised in that the at least one discharge aperture (39) for material to be shredded is provided at one single end area (28) of the roller core (12) and at least one section of the cavity (38) of the roller core (12) expands towards this end area (28) in a cone shape.

3. Shredding roller according to claim 1, characterised in that the longitudinal axis of the roller core (12) is angled in respect of the horizontal, that is, is arranged so that it drops down towards the discharge aperture (39).

4. Shredding roller according to one of the preceding claims, characterised in that one axial/radial bearing device (30′, 30″) of the roller core (12) is provided at one single axial end area (29) of the roller core (12).

5. Shredding roller according to one of the preceding claims, characterised in that a conveying device (40, 54; 60) is arranged in the cavity (38) to convey shredded material from the cavity to the discharge aperture (39).

6. Shredding roller according to claim 5, characterised in that the conveying device includes a belt conveyor (40) with a conveyor belt (42) and two guide rollers (44, 46), the intake end of which is arranged in the cavity (38) of the roller core (12) and the discharge end of which is outside the roller core (12).

7. Shredding roller according to claim 5 or 6, characterised in that the conveying device has a conveying screw (64, 66) which extends into the cavity (38) of the roller core (12).

8. Shredding roller according to claim 7, characterised in that the conveying screw (64) is flexible in at least one section.

9. Shredding roller according to claim 7 or 8, characterised in that the conveying screw (64) is arranged in a fixed position in the space.

10. Shredding roller according to one of claims 7 to 9, characterised in that at least one axial end area of the roller core (12), which has a hollow stump shaft (28), has a smaller diameter than a central zone (65) of the roller core (12) and that the discharge end of the conveying screw (64) extends through the hollow stump shaft (28).

11. Shredding roller according to one of the preceding claims, characterised in that the cutter blades (22) are arranged adjacent to the penetration apertures (36).

12. Shredding roller according to one of the preceding claims, characterised in that the cutter blades (22) take the form of replaceable blades.
